(19) United States
(12) Patent Application Publication
(10) Pub. No.: US 2013/0167498 A1
(43) Pub. Date: Jul. 4, 2013

(54) AGRICULTURAL IMPLEMENT HAVING KNIFE LOAD RESPONSIVE INFEED CUTTER

(71) Applicant: AGCO Corporation, Duluth, GA (US)

(72) Inventor: Alan Haycocks, Kenilworth (GB)

(73) Assignee: AGCO CORPORATION, Duluth, GA (US)

(21) Appl. No.: 13/727,640

(22) Filed: Dec. 27, 2012

Related U.S. Application Data
(60) Provisional application No. 61/581,010, filed on Dec. 28, 2011.

(51) Int. Cl. A01F 15/08

(52) U.S. Cl. CPC A01F 15/08
USPC 56/341

(57) ABSTRACT

An agricultural implement having an infeed cutter is operable to automatically accommodate large objects that pass through the infeed cutter and detect and counteract jams that occur or might otherwise occur in the infeed cutter. The implement includes a plurality of knives mounted on a vertically moveable knife bed. The bed is associated with a hydraulic load-sensing system that is operable to lower the bed if a load threshold has been reached and raise the bed when the load has decreased sufficiently. Each knife is also associated with a hydraulic load-sensing system that is operable to lower the respective knife if a load threshold has been reached and raise the respective knife when the load has decreased sufficiently.

### CROSS REFERENCE TO RELATED APPLICATIONS

This application claims priority to U.S. Provisional Application No. 61/581,010 filed Dec. 28, 2011, entitled “AGRICULTURAL IMPLEMENT HAVING KNIFE LOAD RESPONSIVE INFEED CUTTER”.

### BACKGROUND OF THE INVENTION

This invention relates to agricultural balers, and more particularly, to a knife load responsive infeed cutter configured to accommodate large objects that pass through the infeed cutter and detect and counteract jams that occur or might otherwise occur in the infeed cutter.

### SUMMARY OF THE INVENTION

An agricultural implement having an infeed cutter is operable to automatically accommodate large objects that pass through the infeed cutter and detect and counteract jams that occur or might otherwise occur in the infeed cutter. The implement includes a plurality of knives mounted on a vertically moveable knife bed. The bed is associated with a hydraulic load-sensing system that is operable to lower the bed if a load threshold has been reached and raise the bed when the load has decreased sufficiently. Each knife is also associated with a hydraulic load-sensing system that is operable to lower the respective knife if a load threshold has been reached and raise the respective knife when the load has decreased sufficiently.

In a first preferred embodiment, the raising and lowering of the bed and knives is controlled by monitoring the pressure of the hydraulic system of the infeed cutter. More particularly, the pressure in the hydraulic load-sensing systems associated with the knives is monitored. For each knife, if the associated pressure is found to exceed a given threshold (which can be set by the operator, if desired), the respective knife is retracted to an inoperative position. The pressure is also monitored for the bed. If the pressure associated with the bed hydraulics is found to be acceptable, each of the previously lowered knives is returned to its operative position. If the pressure for the bed exceeds a given threshold (which can be set by the operator, if desired), however, the bed is lowered. The pressure is again analyzed for the bed. If it has not decreased sufficiently, manual maintenance may be necessary. If it has reached an acceptable level, however, the bed is returned to its original position. If the pressure remains acceptable after the bed has returned to its original position, each of the previously retracted knives is raised, and the monitoring process begins anew. If the pressure has returned to an unacceptable level after the bed has returned to its original position, however, the bed-lowering process is again repeated.

In a second preferred embodiment, the raising and lowering of the bed and knives is controlled by monitoring the pressure of the hydraulic system of the infeed cutter. More particularly, the pressure in the hydraulic load-sensing systems associated with the knives is monitored. For each knife, if the associated pressure is found to exceed a given threshold (which can be set by the operator, if desired), the respective knife is retracted to an inoperative position. The knife-based monitoring and, if necessary, retractions continue until all knives have been retracted or the pressure is acceptable for all remaining active knives. The pressure is also monitored for the bed. If the pressure associated with the bed hydraulics is found to be acceptable, each of the previously lowered knives is returned to its operative position. If the pressure for the bed exceeds a given threshold (which can be set by the operator, if desired), however, the bed is lowered. The pressure is again analyzed for the bed. If it has not decreased sufficiently, manual maintenance may be necessary. If it has reached an acceptable level, however, the bed is returned to its original position. If the pressure remains acceptable after the bed has returned to its original position, each of the previously retracted knives is raised, and the monitoring process begins anew. If the pressure has returned to an unacceptable level after the bed has returned to its original position, however, the bed-lowering process is again repeated.

### BRIEF DESCRIPTION OF THE DRAWING FIGURES

Preferred embodiments of the invention are described in detail below with regard to the attached drawing figures, wherein:

FIG. 1 is a side elevational view of a baler having features found in a preferred embodiment of the present invention;

FIG. 2 is an enlarged, fragmentary, longitudinal cross-sectional view through the infeed part of the baler of FIG. 1, illustrating the relationship between the pickup, cutter apparatus, packer, and stuffer;

FIG. 3 is fragmentary longitudinal cross-sectional view similar to that of FIG. 2 but taken somewhat deeper into the baler of FIGS. 1 and 2 to illustrate the relationship between the cutter rotor and strippers associated with the rotor;

FIG. 4 is a fragmentary side elevational view of the infeed area of the baler of FIGS. 1-3, illustrating the latching and release mechanism for the knife bed associated with the cutter apparatus;

FIG. 5 is a fragmentary side elevational view similar to FIG. 4 but showing the knife bed of the baler of FIGS. 1-4 in its fully lowered position;

FIG. 6 is a left, front isometric view of the cutter apparatus of the baler of FIGS. 1-5;

FIG. 7 is a left, rear isometric view of the cutter apparatus of the baler of FIGS. 1-6;

FIG. 8 is a flowchart depicting a preferred sequence of system analyses and resulting actions that occur during the course of a cutting operation using the inventive baler; and

FIG. 9 is a flowchart depicting another preferred sequence of system analyses and resulting actions that occur during the course of a cutting operation using the inventive baler.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

In a preferred embodiment, the agricultural machine featuring the inventive knife load responsive infeed is a baler for making rectangular crop bales. However, it is within the scope of the present invention for the knife load responsive infeed to be part of any of a variety of agricultural machines having an infeed cutter. These machines include round balers, silage trailers, forage harvesters, and others.

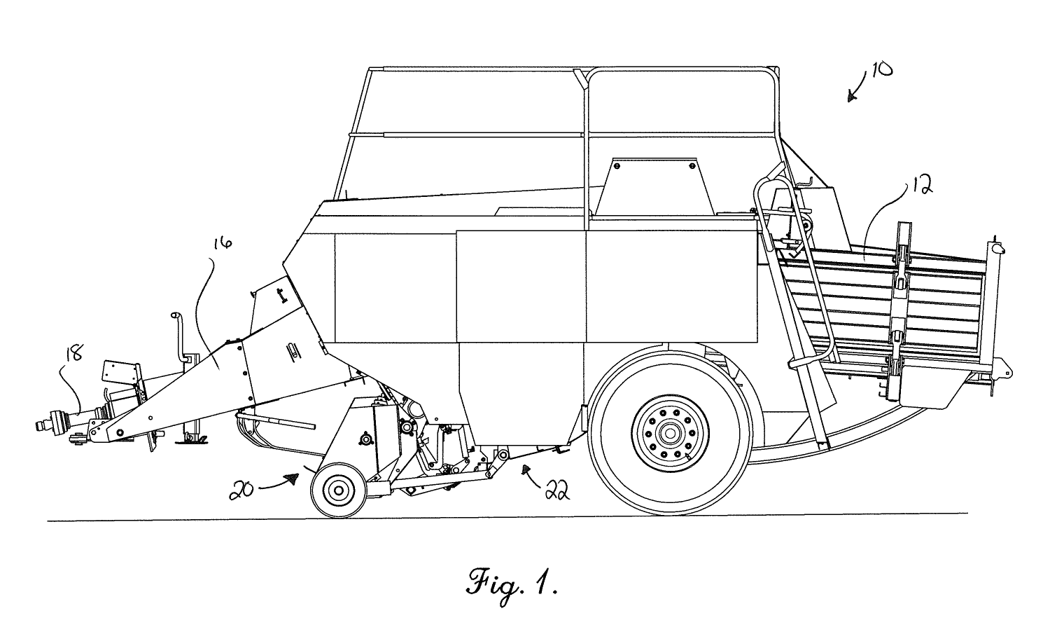

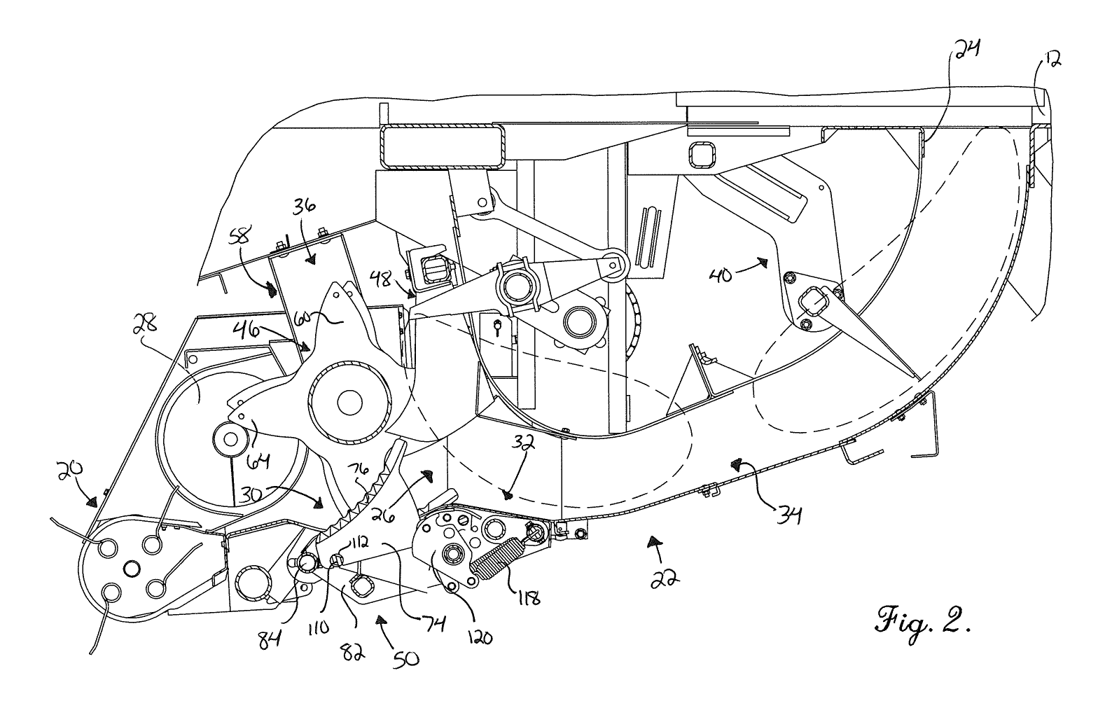

As best shown in FIG. 1, the baler 10 preferably includes a fore-and-aft extending baling chamber, broadly indicated by numeral 12, within which bales of hay are prepared and forced incrementally out the back end of the chamber 12. The baler 10 is hitched to a towing vehicle (not shown) by a fore-and-aft tongue 16, and power for operating the various components of the baler 10 is supplied through a drive line 18 supported by the tongue 16. Preferably, the baler 10 is an “in-line” type of baler wherein crop is picked up directly beneath and slightly ahead of the baling chamber 12 and loaded up into the bottom of the chamber 12 in a straight line path of travel as viewed from the top, although other crop routing configurations may be used without departing from the spirit of the present invention. In keeping with the preferred in-line arrangement, the baler 10 shown in FIG. 1 has a pickup 20 positioned under the tongue 16 such that the pickup 20 is significantly forward of the baling chamber 12. A duct 22, barely visible in FIG. 1, extends generally rearwardly and upwardly from behind the pickup 20 to an opening 24 (see FIG. 2) in the bottom of the baling chamber 12. The duct 22 serves as part of a passage through which crop materials travel from the pickup 20 to the baling chamber 12 during operation of the baler 10.

With primary reference to FIG. 2, it will be seen that the infeed area of the baler 10 generally comprises a passage broadly denoted by the numeral 26 for crop flow that begins just rearwardly of the pickup 20 and ends at the opening 24 in the bottom of the baling chamber 12. Although the crop materials are initially lifted off the ground by the pickup 20 in a relatively wider configuration than the width of the duct 22, such materials are immediately consolidated centrally by an auger mechanism 28 before entering the passage 26. As the consolidated stream of crop materials moves rearwardly from the auger mechanism 28, it passes through a cutting zone 30 immediately behind the pickup 20. The crop materials then pass through a packing zone 32 behind the cutting zone 30 and through an accumulating zone 34 behind the packing zone 32. Within the cutting zone 30, the crop materials are cut into smaller pieces. Within the packing zone 32, the materials have a packing and feeding force applied to them in the downstream direction of flow. Within the accumulating zone 34, the materials accumulate into a charge that is compressed by the packing force and that assumes the configuration of the duct 22 in that area. A stuffer 40 then sweeps the charge up into the baling chamber 12 through the opening 24.

In order to carry out the cutting function within the cutting zone 30, the baler includes a cutter apparatus broadly denoted by the numeral 36. The cutter apparatus 36 comprises three primary components: a cutter rotor 46, a bank of strippers 48 for the rotor 46, and a knife bed 50 cooperating with the rotor 46 to sever the crop materials into smaller pieces. The rotor 46 preferably comprises a series of generally star-shaped blades 60 arranged in a helical or spiral pattern as shown, although V-shaped arrangements or a variety of others are permissible, as well.

Preferably, the rotor 46 is driven in a counter-clockwise direction as viewed from the vantage point of FIG. 2, such that the blades 60 sweep downwardly and forwardly into the cutting zone 30 on the front side of the axis of rotation of the rotor. Conversely, the blades 60 swing upwardly and rearwardly out of the cutting zone 30 behind the axis of rotation of the rotor 46. Thus, crop materials lifted from the field by the picker 20 are propelled by the rotor 46 rearwardly through the cutting zone 30. Crop materials which might tend to be carried by the rotor 46 after the crop materials have passed behind the axis of rotation of the rotor 46 are stripped therefrom by the strippers 48, at which point the crop materials enter the packing zone 32.

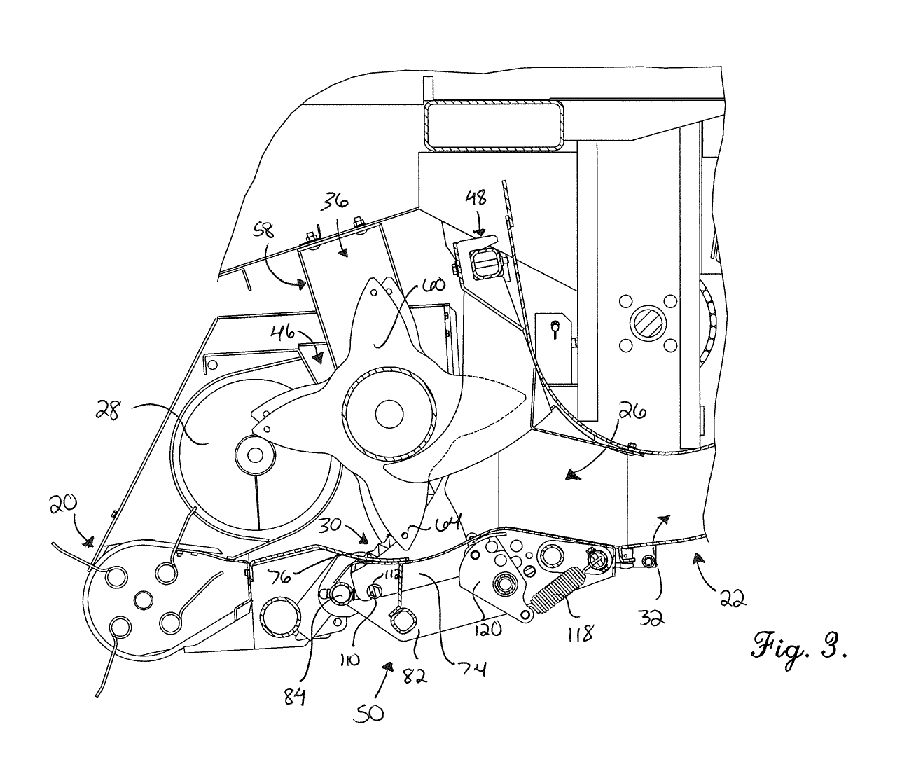

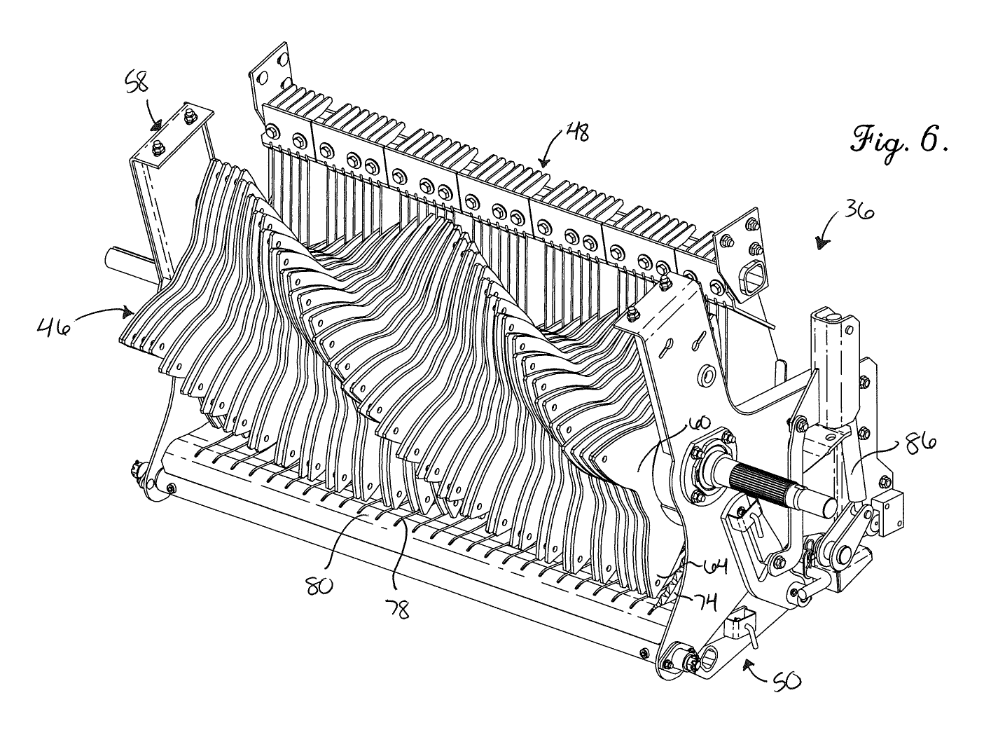

Referring primarily to FIGS. 2 and 3, the knife bed 50 includes a series of knives 74 that cooperate with the points 64 of the blades 60 to reduce incoming crop materials into small pieces when the knives 74 are in their raised, operating positions as illustrated, for example, in FIG. 3. The knives 74 are arranged to project upwardly between each pair of blades 60 so that as the points 64 on a pair of blades sweep downwardly and then rearwardly through the cutting zone 30, they pass on opposite sides of a corresponding knife 74. As shown in FIG. 3, each of the knives 74 has a serrated cutting edge 76 that faces generally upwardly and forwardly when the knife is in its operating position. Although they are not visible in the provided figures, the sides of knives 74 opposite the serrated cutting edge 76 are generally smooth. As shown in FIG. 6, the knives 74 project up through slits 78 in a top wall 80 of the bed 50 when knives 74 are in their operating positions.

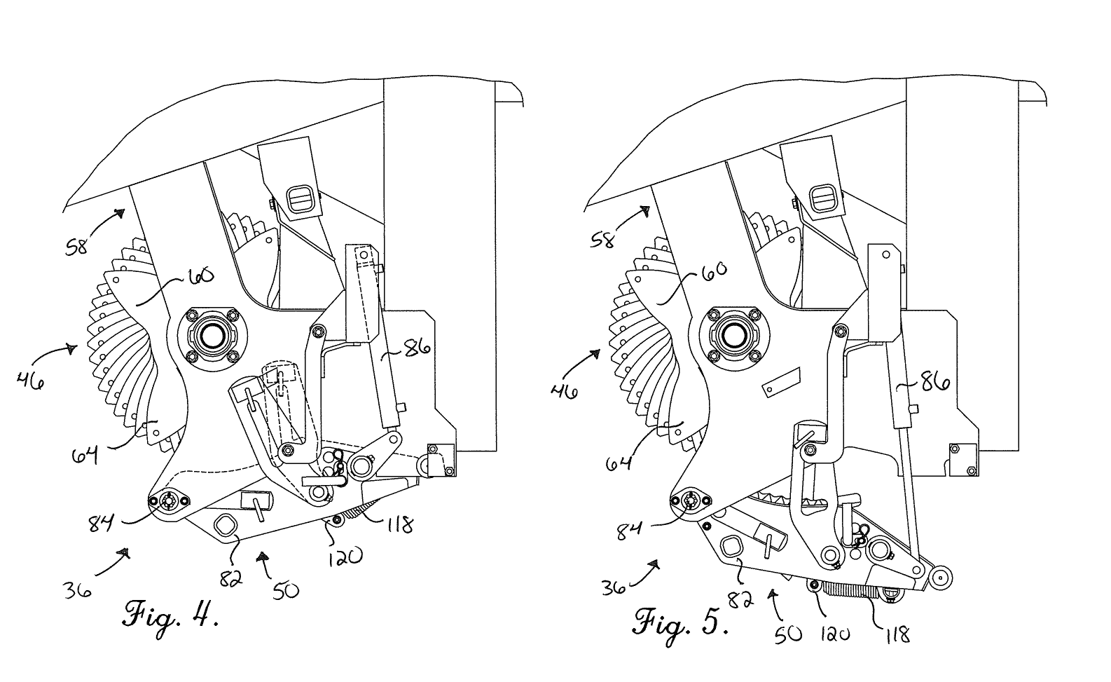

As shown in FIG. 3 and others, the knives 74 are carried by a subframe 82 forming another part of the bed 50. Subframe 82 is connected to the supporting frame 58 for the rotor 46 adjacent the lower forwardmost extremity of frame 58 by a transverse pivot shaft 84 so that the entire knife bed 50 can be raised and lowered between the two extreme positions illustrated in FIGS. 4 and 5. Such raising and lowering is preferably controlled by a pair of hydraulic cylinders 86 on opposite sides of the baler (see, for instance, FIGS. 4 and 5), although a variety of control means fall within the scope of the present invention.

The knives 74 are all mounted at their forward ends onto a common cross shaft 110 that extends the full width of bed 50. A generally circular notch 112 (best viewed in FIGS. 2 and 3) in the lower edge of each knife 74 receives the cross shaft 110. Cross shaft 110 has a pair of opposed flat sides which enable each individual knife 74 to be removed from cross shaft 110 when cross shaft 110 is rotated to a position aligning the flat sides thereof with the entrance into the notch 112 of the knife. At other times, the cross shaft 110 is maintained in such a rotative position that the flat sides thereof are generally transverse to the entrance to the notch 112 of each knife so that the knives cannot be removed from cross shaft 110. As seen in FIG. 5, access to the knives 74 for removing and replacing the same is provided when the bed 50 is in its lowered position.

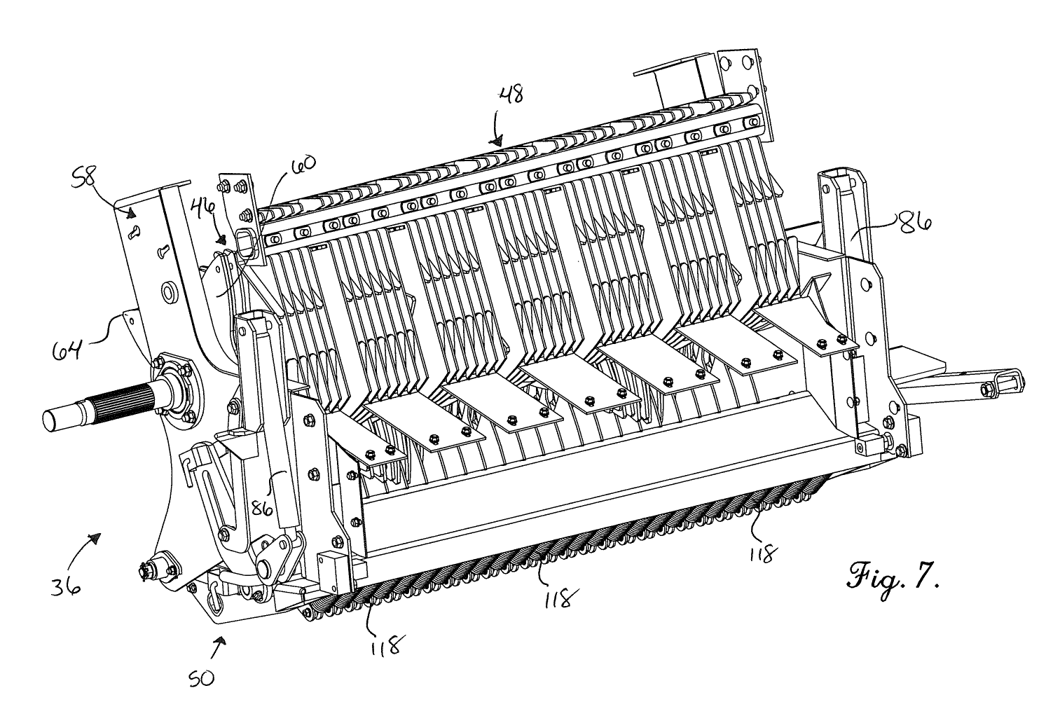

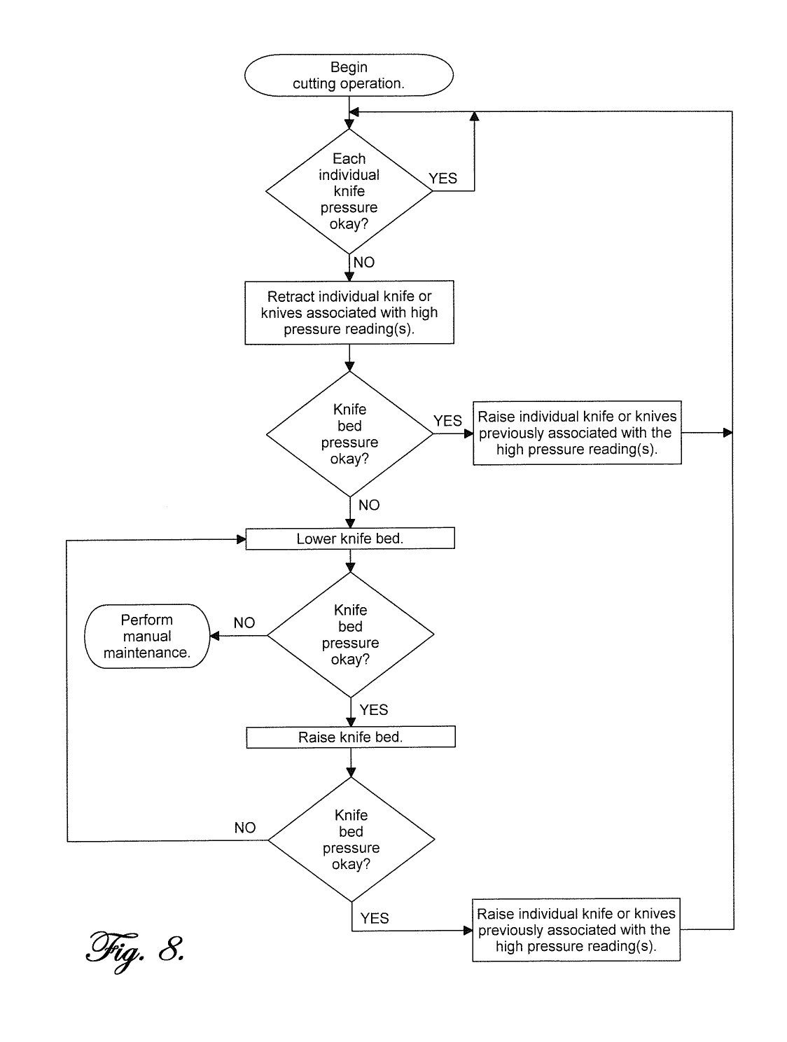

As best shown in FIGS. 2, 3, and 7, each of the knives 74 of the illustrated baler is individually linked to a spring 118 at the back of the knife bed 50. Thus, if a particular knife 74 is raised up into an operating position within the cutting zone 30 as illustrated in FIGS. 2 and 3, the knife can swing down about the cross shaft 110 against the force of its spring 118 in the event that an obstruction or solid object passes through the cutting zone 30 and engages the knife.

The number of knives 74 which are raised up into their operating position when the bed 50 is in its operating position can be selectively varied through control of actuators 120. More particularly, this can be carried out by controlling which of the actuators 120 are allowed to rotate back into their actuated positions by the springs 118 as the bed 50 is raised up into its operating position. In a preferred embodiment, this is accomplished by having the total set of actuators 120 constructed in four different configurations that render it possible to prevent every third actuator from returning, prevent every other actuator from returning, or prevent none of the actuators from returning. In the lattermost situation, all of the knives 74 are thus raised back up to their operating position.

In a preferred embodiment, the knife bed 50 comprises left and right knife beds 50a,50b that retain the features described above but are additionally mobile laterally away from the center of the baler 10 into accessible positions near the lateral margins of the baler 10. In these accessible positions, the beds 50a,50b and, in turn, the knives 74 carried on them, can be easily accessed by an operator for maintenance purposes, troubleshooting, etc.

The movement of knife beds 50a,50b can be manual or automatic and may be implemented by a variety of means. For instance, a handle could be provided for manual sliding upon release of a latch, or a hydraulic system controlled by the operator from the cab could be implemented.

A variety of paths and means of movement of the beds 50a,50b to accessible positions can also be implemented. For instance, each of the beds 50a,50b could be horizontally slideable, laterally pivotable about a vertical axis, or be mounted on rollers carried on laterally extending tracks.

In a preferred embodiment, the pickup 20 has a width of three (3) meters, while each of the knife beds 50a,50b has a width of six tenths of a meter (0.6 meters). However, dimensional variations in any of the components of the baler 10 may be made without departing from the spirit of the present invention.

In a preferred embodiment, between eight (8) and twelve (12) knives 74 are provided on each of the beds 50a, 50b. However, any number of knives 74 may be present without departing from the spirit of the present invention.

Although the preferred embodiments just described refer to left and right knife beds 50a,50b, it is within the scope of the present invention for any number of knife bed sections to be provided, including a single knife bed that is not sectioned. Furthermore, regardless of the number of knife bed sections, it is preferred that at least one and preferably two hydraulic cylinders 86 be provided for controlling swinging movement of each of the knife bed sections.

In a preferred embodiment, at least one knife-sharpening assembly is carried on the baler 10 to provide onboard at least partly automated sharpening of the knives 74. However, a baler 10 providing only for manual sharpening of the knives 74 falls within the scope of the present invention.

In a preferred embodiment, a sensing system (not shown) is provided to allow for continuous monitoring or on-demand reading of the pressure in each of the hydraulic cylinders 86. The pressure readings taken by the sensing system correspond to the forces applied to the respective knife beds 50 or, if applicable, knife bed sections 50a,50b, etc. and can be used as indicators of a large object in or a jam or blockage of the cutting zone 30.

For the sake of clarity, further discussion herein of the sensing system will, unless otherwise noted, refer to the system as applicable to a single knife bed 50. However, it should be understood that it is within the scope of the present invention for the sensing system to be applied to any number of knife bed sections.

In a preferred embodiment, each of the springs 118 is replaced with or supplemented by a hydraulic knife cylinder (not shown). In addition to monitoring the pressure in cylinders 86, the sensing system monitors the pressure in each of the knife cylinders, either continuously or on demand. These pressure readings correspond to the forces applied to the individual knives 74 and can be used as indicators of a large object in or a jam or blockage of the cutting zone 30.

In an alternate embodiment, a single hydraulic knife cylinder could be associated with multiple knives 74.

A variety of hydraulic system arrangements for the sensing system are suitable for use with the inventive baler 10, as long as (1) the system is arranged such that pressure readings taken at appropriate locations correspond to appropriate forces on the knives 74 and the knife bed 50, and (2) sufficient “cushioning” is available in the system (due to judicious placement of accumulators, for instance) to allow raising and lowering of the knives 74 and knife bed 50.

As will be described below, the baler 10 is operable via the sensing system to automatically detect and counteract jams or obstructions caused by crop materials or other matter that has entered the cutting zone 30.

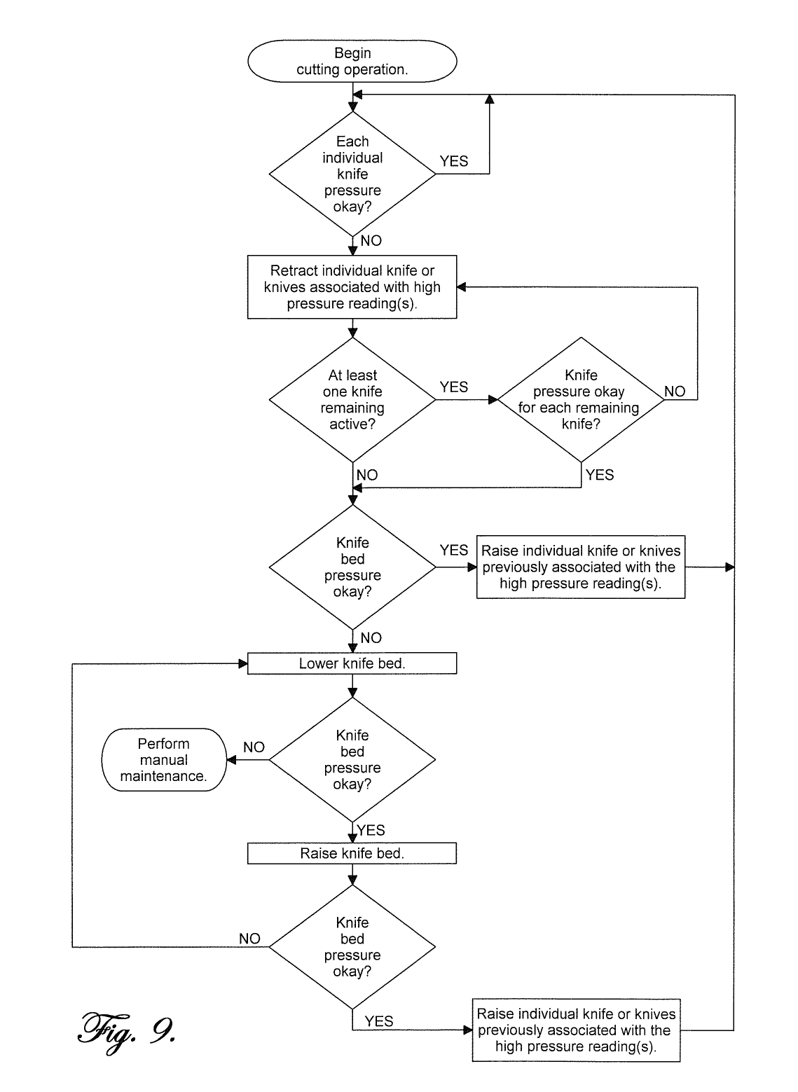

Although many variations are acceptable, the flowchart in FIG. 8 illustrates a preferred operational sequence. First, upon initiation of the cutting operation (which typically corresponds with baling operations by the baler 10), the system monitors the pressure of the cylinder associated with each individual knife 74 and compares this to a user- or system-defined threshold level. As described previously, each pressure reading corresponds to the force applied to the associated knife. If the crop is flowing smoothly, a relatively low reading (below the threshold pressure) will result. If the crop is jammed or if a large object engages one or more of the knives 74, however, the force applied to these knives 74 at or near the jam (or object) will increase, resulting in a relatively high reading (presumably a pressure that will exceed the threshold). Therefore, if the pressure for each knife 74 is acceptable, one can reasonably assume that the crop is flowing freely through the cutting zone 30 and that no action beyond continued monitoring (which may be either continuous or intermittent) is necessary. If the reading for a given knife 74 is greater than the threshold, however, that knife 74 should be retracted through a respective slit 78 so that it is positioned below the top wall 80 of the bed 50. The number of knives 74 that are (essentially simultaneously) retracted at this stage can therefore range from zero to all. Such retraction reduces the risk of knife damage and undue knife wear. Further, the block (or object) will hopefully be permitted to pass through the cutting zone 30 and on to the baling chamber 12. Preferably, before any retracted knives 74 are returned to the operating position, the bed pressure is sensed, as described below.

Again, in some instances, refraction of a knife 74 associated with a high force will allow the jammed material located near the respective knife 74 to pass on through the cutting zone 30 and into the packing zone 32 and the baling chamber 12. In the case of a large jam, however, the material may remain stuck between the rotor 46 and the top wall 80 of the knife bed 50, despite a knife or knives 74 having been previously retracted. Therefore, as briefly noted, the system also involves monitoring of the pressure of the cylinder(s) associated with the knife bed 50. Preferably, subsequent to the knife pressure exceeding its threshold value for one or more knives 74, the system will analyze the pressure associated with the knife bed 50 to avoid premature lowering of the bed 50. If the knife bed pressure (and thus the force being applied to it) is acceptable, again based on a user- or system-defined threshold, this indicates that the jam has likely cleared and the previously refracted knife or knives 74 can be raised. Furthermore, the acceptable reading indicates that lowering of the knife bed 50 is unnecessary. The original monitoring of individual knife pressures can then continue as previously. If the bed pressure is unacceptably high, however, this indicates that the jam likely has not passed through to the packing zone 32, in spite of the retraction of the selected knife or knives 74. The knife bed 50 is then lowered to allow significant clearance between the top wall 80 of the knife bed 50 and the bottom margins of the rotor 46 so that remaining jammed materials can pass freely therebetween.

As shown in FIG. 8, after lowering of the knife bed 50, the system again analyzes the knife bed pressure. In most instances, the jam will have cleared, and an acceptable pressure will have been restored. If this is the case, the knife bed 50 is raised again to its original position. If not, manual maintenance may be necessary to clear the jam or, if no jam is present, to identify the cause of the high pressure reading.

The system can be configured to lower the bed 50 only incrementally to progressively “widen” the cutting zone 30 until the bed pressure drops below the threshold, or the bed 50 can be lowered completely so that the material (or object) may be permitted to drop to the ground. Furthermore, any remaining operable knives 74 can be retracted prior to lowering of the bed 50, despite no high pressure reading having been previously associated with them, in order to maximize the available clearance area between top wall 80 of the knife bed 50 and the bottom margins of the rotor 46.

Assuming the knife bed 50 has been raised, the next step is to confirm the clearance of the jam by again analyzing the knife bed pressure. As before, if the pressure is too high, the knife bed must be lowered. If the pressure is acceptable, however, the previously retracted knife or knives 74 can be raised, and the sequence begins anew with analysis of the pressures associated with each individual knife 74.

An alternative preferred operational sequence is illustrated by the flowchart in FIG. 9. As shown, the initial monitoring of pressures associated with knives 74 and, if necessary, retraction of individual knives 74 is the same as that for FIG. 8. However, the procedure illustrated in FIG. 9 is designed to, as much as possible, avoid the cutting stoppage that would occur if the bed 50 were lowered.

Consider, for instance, a jam that occurs against a first blade 74. After retraction of the first blade 74, the jam might shift or enlarge so as to apply a force to a second blade 74. Following the procedure shown in FIG. 8, which includes only one round of retractions of knives 74 before the pressure associated with the bed 50 is analyzed, the continued presence of the jam would result in lowering of the bed 50 and either a decrease in bale quality as crop material passes uncut into the packing zone 32 or a loss of crop material that falls out of the baler 10. As shown in FIG. 9, however, a process could be implemented whereby a jam or blockage would not result in lowering of the bed 50 unless all of the knives 74 had already been retracted due to associated high pressure readings. In other words, the bed 50 would only be lowered under two circumstances. In the first of these circumstances, all knives 74 have been retracted (either simultaneously or over the course of multiple rounds of analysis) due to associated high pressure readings, yet the pressure reading for the bed 50 is unacceptably high. That is, the jam could not be cleared by simply retracting all of the knives 74; so the bed 50 must be lowered. In the second circumstance, the initial retraction of a high-pressure knife or knives 74 has not led to a shift or enlargement of the jam to result in increased pressure to another knife or knives 74 (as indicated by acceptable pressure readings for all remaining knives 74), and the pressure reading for the bed 50 is unacceptably high. The jam therefore cannot be cleared by simply retracting additional knives 74, so the bed 50 must be lowered.

Although the physical actions taken in the second instance are identical to those shown in the sequence of FIG. 8, these actions would have been taken in the FIG. 8 sequence regardless of whether or not simply retracting an additional knife 74 would have allowed clearance of the jam. That is, in the FIG. 8 sequence, a single failed attempt to clear the jam based on retraction of a knife or knives 74 (as indicated by a high pressure reading being associated with the bed 50 after the knife or knives 74 were retracted) always leads to lowering of the bed 50. This sequence would hopefully lead to consistently quick clearance of jams, but at the expense of lost cutting time. In contrast, in the FIG. 9 sequence, a single failed attempt to clear the jam based on retraction of a knife or knives 74 (as indicated by a high pressure reading being associated with the bed 50 after the knife or knives 74 were retracted) would only lead to lowering of the bed 50 if no additional knife or knives 74 presented an associated high pressure reading. That is, the bed 50 would be lowered only if it were indicated that additional knife 74 retractions would provide no benefits (i.e., the remaining knives 74 were associated with acceptable pressure readings and therefore were not contributing to the jam). This sequence would hopefully avoid lowering of the bed 50 unless absolutely necessary, with small jams being dealt with by sequential knife 74 retractions (i.e., retractions taking place over the course of several rounds of analysis) rather than by a single round of knife 74 retractions followed by bed 50 movement, to ensure that cutting operations could continue uninterrupted for the remaining knives 74.

The remainder of the sequence corresponds to that described above with reference to FIG. 8. Ultimately, however, as briefly noted above, the sequence illustrated by FIG. 9 may allow greater total cutting time than that illustrated by FIG. 8. For instance, using the sequence of FIG. 8, a jam at the leftmost end of the bed 50 that cannot be cleared by retraction of the leftmost knife 74 would result in lowering of the entire bed 50 and subsequent stoppage of all crop cutting. Using the process of FIG. 9, however, the same jam could potentially be cleared through the retraction first of the leftmost knife 74 and next of the adjacent knife 74. Only two knives 74 would be inoperable during this time, with the bed 50 remaining raised and the cutting process continuing for the remaining knives 74. Of course, either of these approaches would save significant time relative to that required for an operator to leave the cab of the baler 10 and manually remove any blockages.

The timing of the above-described processes could be varied as necessary to optimize the system. In the case of the FIG. 9 sequence, for instance, frequent knife 74 pressure analyses to trigger, if necessary, very rapid retraction of multiple knives in sequence would be desirable to ensure that little time is lost in case of a jam large enough to ultimately necessitate lowering of the bed 50. In contrast, in both of the main discussed procedures, a knife bed 50 pressure analysis might ideally be delayed for some time after lowering of the knife bed 50 occurs so that a high pressure reading would not take place until sufficient time had been provided for the rotor 46 to sweep the jammed material away. This would ensure that an unacceptably high reading, which would indicate the potential need for manual maintenance, would not usually be a result of pressure from a blockage that was only moments away from be successfully cleared by the rotor 46.

Although two preferred sequences have been described in detail herein, a variety of algorithms could be implemented without departing from the spirit of the present invention. For instance, the system could include multiple analyses over a set period of time at each stage or selected stages. The multiple analyses could be used to, for example, confirm that a high pressure reading is not simply a result of a transient condition such as rock glancing off a knife 74 or a jam that quickly worked itself out.

As briefly noted, the threshold values could be user- or system-defined. They could also be a combination of both. In one embodiment, the user could input information about the crop material being baled and the current baling environment, and the system would provide suggested threshold values that the user could either accept or modify. Furthermore, the threshold values could vary for retraction/lowering versus raising, or they could vary according to the position at which the measurement was taken. That is, the pressure threshold for a knife 74 at one position on the knife bed 50 could be different from that for a knife 74 at a different position on the knife bed 50.

Furthermore, if a split knife bed 50 were used, as described previously, the sensing system could be modified to analyze each of the bed sections and the respective knives 74 carried thereon independently of the other bed sections and associated knives 74. In such an embodiment, even less disruption to the cutting process could be expected, since a jam that spreads across multiple bed sections to the extent that more than one bed section required lowering would be unlikely.

Even further, if a single hydraulic knife cylinder were associated with several knives 74, groups of knives 74 could be raised and lowered rather than individual knives 74.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention.

What is claimed is:

1. An agricultural baler comprising:
an infeed cutter comprising a plurality of knives mounted on a vertically moveable knife bed; and
a hydraulic load-sensing system operable to lower the bed when a load threshold is exceeded and raise the bed when the load threshold is no longer exceeded such that the infeed cutter is operable to automatically accommodate large objects that pass therethrough.

2. The agricultural baler of claim 1 wherein each knife is associated with said hydraulic load-sensing system so as to lower the respective knife when a load threshold has been reached and raise the respective knife when the load has decreased below said threshold.

3. A method for controlling an infeed cutter of an agricultural baler, wherein the infeed cutter has a plurality of knives mounted on a vertically moveable knife bed, the method comprising:
monitoring pressures in a hydraulic load-sensing systems for each of the knives and also for the knife bed;
retracting at least one knife to an inoperative position when an associated pressure for said at least one knife is found to exceed a given threshold;
returning each of the previously retracted knives to its operative position if the pressure associated with the knife bed hydraulics is below a threshold;
retracting the knife bed if the pressure for the knife bed exceeds a threshold for the bed;
analyzing the pressure for the bed;
returning the bed to its original position if the bed pressure has reached an acceptable level; and
raising each of the previously retracted knives if the bed pressure remains acceptable after the knife bed has returned to its original position.
